(19) United States
(12) Patent Application Publication
(10) Pub. No.: US 2008/0155538 A1
(43) Pub. Date: Jun. 26, 2008

(54) Computer usage management system and method

(76) Inventor: Matthew S. Pappas, Las Vegas, NV (US)

Correspondence Address: DLA PIPER US LLP, 2000 UNIVERSITY AVENUE, E. PALO ALTO, CA, 94303-2248, US

(21) Appl. No.: 11/375,412

(22) Filed: Mar. 13, 2006

Related U.S. Application Data
(60) Provisional application No. 60/661,603, filed on Mar. 14, 2005.
(60) Provisional application No. 60/727,692, filed on Oct. 17, 2005.

(51) Int. Cl. G06F 9/44

(52) U.S. Cl. 718/100

(57) ABSTRACT

A manager tool system and method are provided wherein the use of the computer system by a user is controlled and monitored. The system also requires the user to engage in a learning process during the use of the computer system in order to be able to continue using the computer system. In a preferred embodiment, the learning process may be a series of questions that must be correctly answered before any further use of the computer system is permitted.

### PRIORITY CLAIMS

This application claims priority under 35 USC 119(e) and 120 to U.S. Provisional Patent Application Ser. No. 60/661,603 filed on Mar. 14, 2005 and entitled “Learn then play system” and U.S. Provisional Patent Application Ser. No. 60/727,692 filed on Oct. 17, 2005 and entitled “Computer Usage Management System and Method”, both of which are herein incorporated by reference.

### FIELD OF THE INVENTION

The application relates generally to a computer usage management system and in particular to a computer-implemented system and method that provides substantive training during the computer use.

### BACKGROUND OF THE INVENTION

A computer system is a very valuable tool for performing various tasks, such as email communications, word processing, research and the like. However, when used by a child, the computer system is often used for non-educational activities, such as games or surfing the web. Although it would be difficult to prevent a child from ever using the computer system for non-educational uses, it is desirable to be able to manage the use of the computer by the child. In addition, it would be desirable to be able to cause the child to use the computer system for learning activities during the use of the computer system. In addition, it would be desirable to be able to require the child to perform one or more educational tasks in order to continue the use of the computer system.

Conventional systems exist for attempting to provide educational training to the user of the computer system. For example, one system is tied to a game application that includes a timer, functions and operations tied to the game application. Using this system, if the user is running a game and the educational program starts, the game is suspended and the person using the computer must answer questions before continuing the game. However, this system only controls the use of the specific game and does not control the use of the entire computer system. Thus, it is desirable to provide a computer usage management system and method and it is to this end that the present invention is directed.

### SUMMARY OF THE INVENTION

The computer usage management system and method are provided in which the usage of the computer system by a user, such as a child, can be controlled. In order to control the usage of the computer system, the management system controls the operating system of the computer system. The management system may present a series of questions to the user and the user must respond to the series of questions before continuing to use the computer system. The management system may also prevent the user from using a particular set of prohibited programs.

### BRIEF DESCRIPTION OF THE DRAWINGS

FIG. 1A is an example of a computer system that may implement the computer usage management system in accordance with the invention;

FIG. 1B is an example of a computer server system that may implement the computer usage management system in accordance with the invention;

FIG. 2 illustrates more details of the computer usage management system implemented using the computer system shown in FIG. 1;

FIG. 3 is a diagram illustrating more details of the management tool in accordance with the invention;

FIG. 4 illustrates the installation and configuration of the management tool client engine in accordance with the invention;

FIG. 5 illustrates the operation of the management tool in accordance with the invention when the operating system of the computer system is started;

FIG. 6 illustrates an aspect of the operating system monitoring in accordance with the invention during which use times and limits are checked;

FIG. 7 illustrates another aspect of the operating system monitoring in accordance with the invention during which security program running status is checked;

FIG. 8 illustrates another aspect of the operating system monitoring in accordance with the invention during which prohibited programs and processes are checked;

FIG. 9 illustrates another aspect of the operating system monitoring in accordance with the invention during which learning/exam trigger conditions are checked;

FIG. 10 illustrates a learning and examination process in accordance with the invention;

FIG. 11 illustrates the learning and examination process for non-subscription users in accordance with the invention;

FIG. 12 illustrates the learning and examination process for subscription users in accordance with the invention;

FIG. 13 illustrates server side processing in accordance with the invention;

FIG. 14 illustrates an example of the parent functions in accordance with the invention;

FIG. 15 illustrates an example of the client engine configuration user interface in accordance with the invention;

FIG. 16 illustrates an example of the learning/testing user interface for a non-subscriber in accordance with the invention;

FIG. 17 illustrates an example of a management tool message in accordance with the invention;

FIG. 18 is an example of a single user configuration user interface of the system;

FIG. 19 is an example of a multiple user configuration user interface of the system;

FIG. 20 is an example of a user interface for setting configuration settings for a particular user;

FIG. 21 is an example of a user interface for setting configuration settings for a parent/administrator;

FIG. 22 is an example of a user interface for setting restricted programs or websites for a particular user;

FIG. 23 is an example of a user interface for setting time restrictions for a particular user;

FIG. 24 is an example of a user interface for configuring the homework and notification module;

FIG. 25 is an example of a user interface for setting restricted programs or websites for all users for a particular computer system;

FIG. 26 is an example of a user interface for adding a new program restriction;

FIG. 27 is an example of a user interface for selecting a restricted program;

FIG. 28 is an example of a user interface for parental/administrator override;

FIG. 29 is an example of a user interface for a math screen for a five year old;

FIG. 30 is an example of a user interface for a math screen with hints;

FIG. 31 is an example of a user interface for logging into the system;

FIG. 32 is another example of a user interface for logging into the system;

FIG. 33 is an example of a user interface for secure login to the system;

FIG. 34 is an example of a menu that appears for the system;

FIG. 35 is an example of a system message;

FIG. 36 illustrates an example of a school system that integrates the learn then play system;

FIG. 37 is a flowchart illustrating a method for school homework control; and

FIG. 38 illustrates an example of a television interface box that incorporates the learn then play system.

### DETAILED DESCRIPTION OF A PREFERRED EMBODIMENT

The invention is particularly applicable to a personal computer implemented usage management system and method and it is in this context that the invention will be described. It will be appreciated, however, that the system and method in accordance with the invention has greater utility since the system can be implemented on a variety of different computers and computing devices, such as wireless PDAs, laptop computers, computer game consoles, set-top box, personal computer and the like.

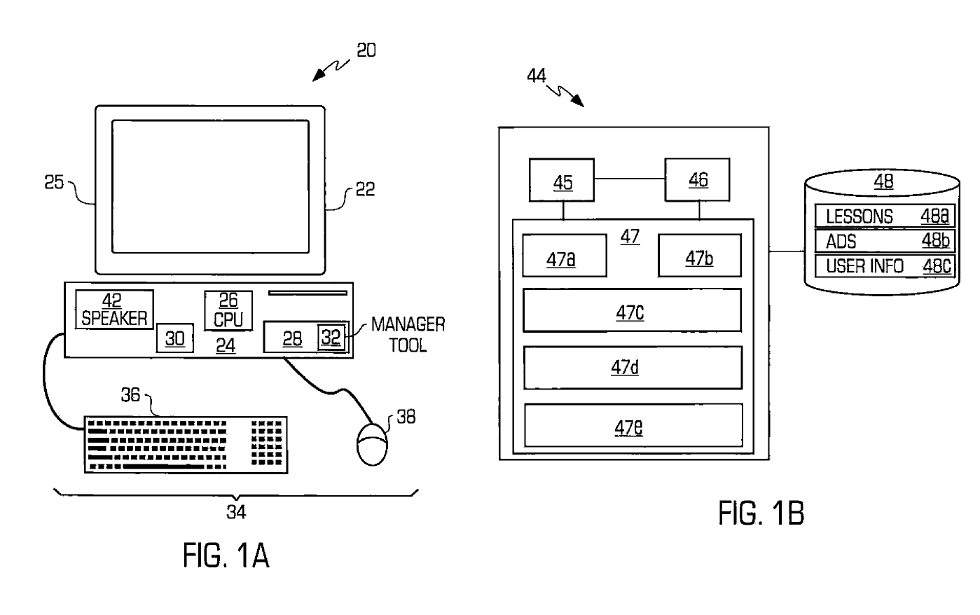

FIG. 1A is an example of a computer system 20 that may implement the training system 22 in accordance with the invention. In a preferred embodiment, the computer system may be a typical desktop personal computer system that has a chassis 24 and a display unit 25 wherein the chassis contains the other known components of the computer system including one or more processors 26, such as a CPU as shown in FIG. 1, a temporary memory 28, such as DRAM, for storing the software and programs being executed by the processor and a persistent storage device 30, such as a hard disk drive, tape drive, flash memory and the like, for storing the data and software associated with the computer system that maintains the storage of the software and data even when no power is being supplied to the computer system as is well known. When the training system in accordance with the invention is being executed by the computer system, the memory 28 may store a manager tool module 32 and an operating system (now shown) such as Windows XP in the preferred embodiment of the invention. The computer system may also include one or more input/output devices 34, such as a keyboard 36, a mouse 38 and a speaker 42 as shown in FIG. 1A, that permit the user to interact with the computer system and the software being executed by the computer system. In the training system, the input/output devices permit the user of the computer to respond to the questions posed by the training software in accordance with the invention. The client may also include a connection to the internet or other computer network (either wired or wireless) so that the client can communicate with the server as needed.

FIG. 1B is an example of a computer server system 44 that may implement the computer usage management system in accordance with the invention. The client portion of the learn to play system may operate without the server in the unsubscribed/basic mode. However, the client operates together with the server 44 when the system is operated in the subscriber/enhanced mode. The server 44 may be a typical server computer that has components such as one or more processors 45, one or more persistent storage devices 46 that store applications and data and does not lose the applications/data when the server is powered down. The server may also have a memory 47, such as DRAM or SRAM, that stores the applications and data currently being executed by the one or more processors, and a storage unit 48. In a preferred embodiment, the server components of the learn then play system is implemented as one or more pieces of software that are executed by the server. Thus, in order to implement the learn then play system in accordance with the invention, the memory may store an operating system 47a that controls the overall operation of the server, a web server application 47b that establishes a connection with a client, serves web pages (described below) to the client and receives data from the client, a learning module 47c, a configuration module 47d and a user interface module 47e. The learning module may control the learning component of the client and communicate with the training logic located on the client, the configuration module configures the learning and computer usage control functions of the system and permits an administrator/parent to configure these functions and the user interface stores the web pages that may be downloaded to each client. The storage unit 48 may store data associated with the system, such as lesson data 48a, ad data and information 48b and information about each user of the system 48c, such as configuration for each user, the scores for each user and the like.

The server may perform various functions as part of the system. For example, the client may receives learning materials (outside of the basic math learning contained in the basic version) from the learning module of the server system. In particular, the client operating system control features include the client's subscription-based learning component. This feature, when subscription features are enabled by the user, provides the user id and subscriber id to the Learn then Play server component at learnthenplay.com website so that the server can then look up the user id and subscriber id and finds age, skill level, subjects, subscription level, etc (configuration information for the user.) The server then uses a process to gather questions from the appropriate subjects and learning materials from subjects that will be provided to the user on the client side based on the configuration information for the user. In operation, the learning module may return the first piece of learning material to the client (and therefore the particular user using the client at that time.) As questions are answered or learning is completed, that information is coming from the server and appears in the client's browser object that is part of the client's operating control mechanism. The client can detect when learning/testing is complete through a signal sent from the server to the client (in the page URL or via the socket component). All results are tracked on the server which then, based on user preferences, increases difficulty, provides reports to parents, etc.

The configuration module of the server permits the administrator/parents to login to the server and configure use times, control mechanisms, restrictions, force immediate shutdown, extend time use, send messages, upload specific learning information—for particular children or groups of children associated with the administrator/parent's subscription. In operation, the administrator/parent logs into a webpage, provides secured login information and then chooses the users or groups of users for which they would like to configure the system. The user interface (described below) provides a tab-based user interface to get to different configurable areas. For instance, if particular spelling words need to be reviewed by a particular child, the parent can tell the LTP server to feed out those words (or any number of various kinds of learning materials) to the child or non-child user. In a non-child situation, it might be an administrator wanting to ensure a specific user or class of users reviews a mandatory new policy or watches a mandatory video.

The server may also include a how-to module so that the Learn then Play server and client also attach to the Learn then Play How To system that allows a provider (any person or entity whether a user of the learn then play system or not) to create a standardized learning system (for instance, how to fix a radiator) and to choose the method by which the learning is delivered (i.e. video, via “Learn then Play Browser Book”, paged learning, —there are a number of delivery methods) and whether there is an exam attached, etc. In accordance with the invention, the provider uses the Learn then Play server configuration tool to create a learning area, pick the subject areas and subcategories the information belongs to and how it is delivered. The provider then enters or uploads the training materials. The provider can indicate whether there will be a charge for the materials and then go through LTP to collect this fee, a portion of which is retained by LTP. The provider can add advertisers to their “How To” areas on ad rotators as well. Then, users on the LTP client can choose to go to a “How To” section of the “How To” section can be accessed right from any Web browser. The user can search on keywords or see an index by major areas drilled down by subcategories (the “How To” Directory). In a preferred embodiment, the providers are not charged to provide materials unless they want to be listed higher in the “directory” and they also must share a percentage of any fees or advertising revenue derived from their “How To” area. The “How To” also allows “localized” learning so people in specific areas see providers in their locales or within regions or subject areas similar to the occupation or demographic of the accessing user. The “How To” areas also allows entities, communities, etc. to setup learning areas on the Learn then Play system and then allows users to quickly and easily find information on how to do something or learn something (from recipes to auto mechanics to programming, etc.) that is then delivered in a very consistent, standardized manner.

The server may also include a notification module (not shown in FIG. 1B) and each user of the client receives the Learn then Play notification module as part of the client. At configuration time, the user can be configured to be associated with a particular teacher/school/school system/tutor so that assignments can then be received via the notification system from the particular teacher/school/school system/tutor. The notifier (the notification portion of the client) permits the user to see all assignments and provides a messaging interface. A teacher/tutor then has a server side interface where they can add homework. The server portion of the notification module may include one or more consistent homework adding formats including worksheet formats that allow the teachers to provide materials out electronically. The notification module and notifier may permit answers to be received electronically and, for certain types of homework, graded and recorded automatically via the Learn then Play client/server component. Grade and other student information can be communicated via the server component's email features to parents automatically based on teacher settings. The Learn then Play can be configured on the administrator side to require homework completion on the notification list before control of the system is turned back over to the student user. The client configuration screens show how this is configured. If parental activation is required to approve or unlock after homework completion, activation can be via a handheld computer, phone (dial number, type quick code, hang up) or the LTP Website or directly on the client itself. If all homework is received electronically via the LTP system, use activation is automatic by LTP client if the restriction is enabled requiring completion prior to usage. In accordance with the invention, the testing and training of the learn then play system can be conducted via this component as well.

The server also permits students/teachers and users to collaborate with each other in a safe collaboration area that allows students to setup profiles and communicate with other students, teachers and/or tutors regarding questions, issues, materials—learning. The students can chat with each other, post questions, ask questions in subject areas. All chat, content, postings are monitored—no demographic, name or other information is allowed out or in—any prohibited words or postings are intercepted. The system allows students and teachers to have their own areas on the server for posting and discussion forums. Now, the client portion of the system will be described in more detail.

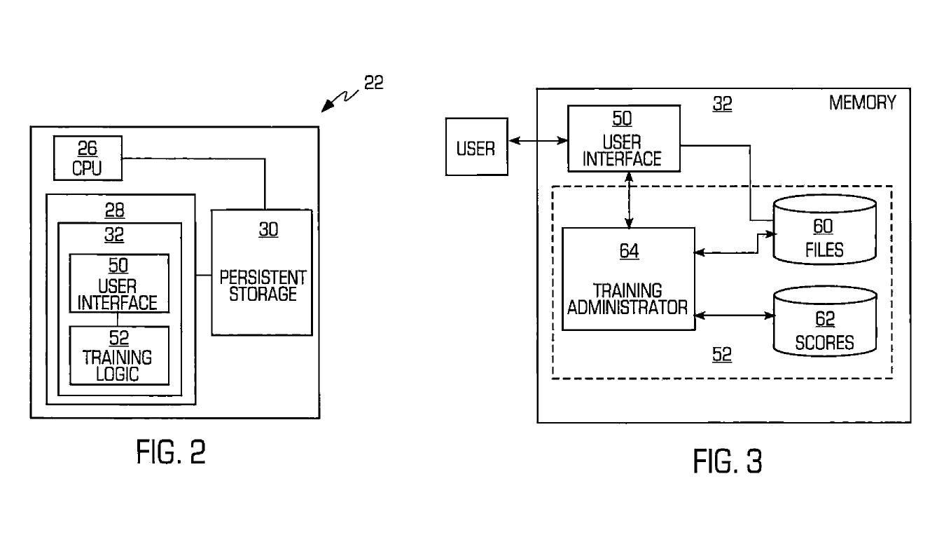

FIG. 2 illustrates more details of the training system 22 implemented using the computer system shown in FIG. 1. In the preferred embodiment, the training system is implemented as one or more pieces of software code that are loaded onto the computer system and then executed by the processor of the computer system to implement the training system in accordance with the invention as described below in more detail. Thus, as shown in FIG. 2, when the training system is in use, the memory 28 may store the manager tool 32 (that may comprise one or more piece of software modules (wherein each module comprises a plurality of lines of computer code) including a user interface module 50 and a training logic module 52. In a preferred embodiment, the manager tool may be known as a client engine in accordance with the invention. The user interface module 50 may generate the visual or audible or audiovisual screens, cues or the like to the user during the execution of the manager tool while the training logic module 52 controls the overall operation and functioning of the manager tool in accordance with the invention. FIG. 3 is a diagram illustrating more details of the manager tool in accordance with the invention wherein the training logic 52 may further comprise a question store 60 and a scores store 62 as well as a training administrator 64. The stores 60, 62 may be implemented in various well known manners by which data can be stored in the software. The question store may store a plurality of questions that are presented to the user for a response prior to permitting further use of the computer while the scores store may store data about the user's responses to the questions posed to the user. The scores may be used to assess whether more difficult questions are appropriate for the user so that the questions posed by the manager tool adjust in difficulty based on the prior responses of the user.

In accordance with the invention, the manager tool may provide various features and capabilities. The manager tool is an operating system control mechanism that controls the use of the computer system and requires a user to answer questions during the usage of the computer system. Thus, even if the user is playing a video game on the computer system, the user must respond to questions (that test the user in various scholastic areas) in order to continue to use the computer system. The manager tool may disable various operating system functions, such as the task manager, the clock, access to the registry, certain keyboard functions and/or access to administrative tools, to ensure that the user must perform the training periodically prior to continued use of the computer system. The manager tool also limits the usage time of the computer system and shuts down computer automatically at/after specific times, after specific use period (configurable), based on performance and types of programs used as described in more detail below with reference to FIG. 9. The manager tool also allows parents to specify applications that the operating system will terminate if the child user tries to open or start as described in more detail with reference to FIG. 8. The manager tool may also provide parental bypass features on the computer system to allow the parent to override the operating system controls, timers, tests and related functions. The manager tool also tracks historical information on the child's use of the computer and test results and connects via Internet to Learn then Play.com to obtain updates, advertising and new features/functions. The basic version of the preferred embodiment of the manager tool may provide math questions (+, −, *, /) and enhanced content for subscriber users based on total computer use time and several other factors.

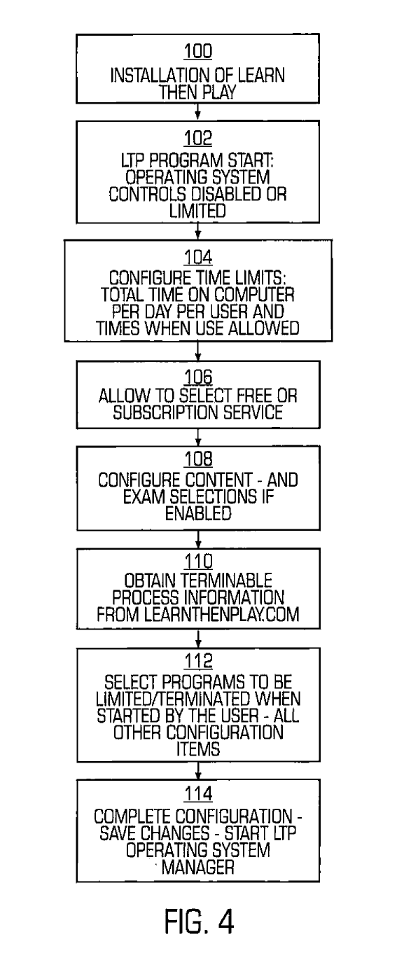

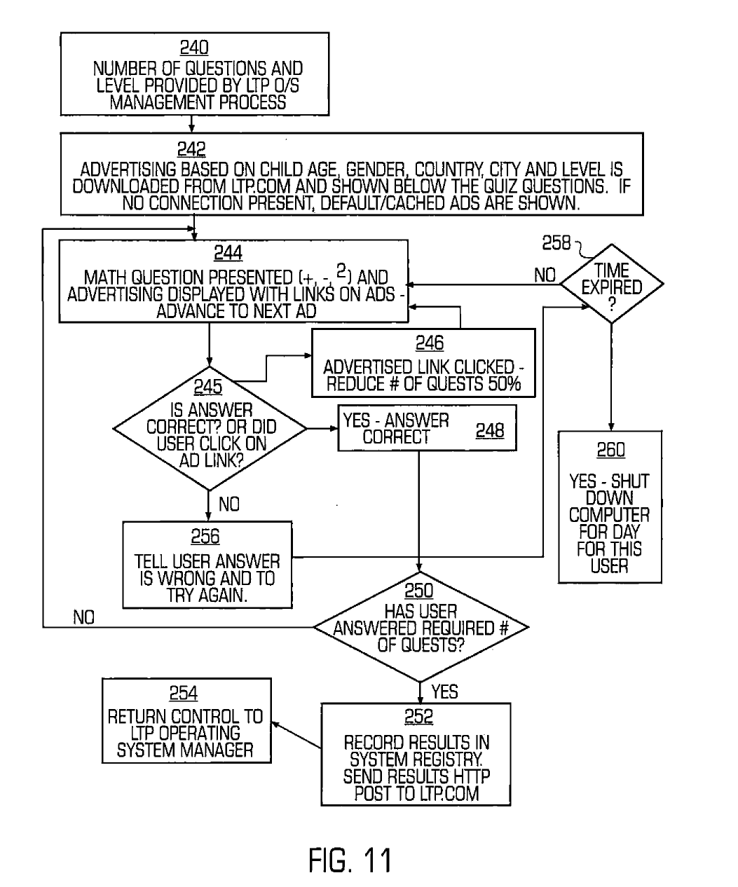

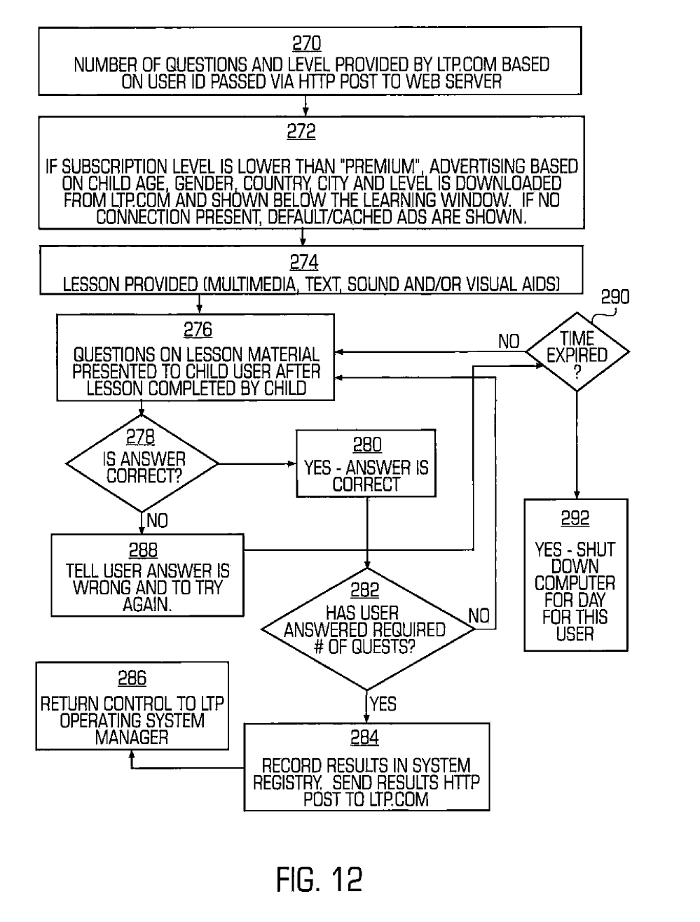

FIG. 4 illustrates the installation and configuration of the manager tool client engine in accordance with the invention. In general, the user of the computer may be a child that must interact with the manager tool to use the computer system and an administrator of the system may be a parent of the child or another adult that is going to use the manager tool in accordance with the invention to control the use of the computer system. In step 100, the administrator installs the learn then play (LTP) software client engine (the manager tool) onto the target computer system. In step 102, the LTP software is started so that the operating system controls are disabled or limited. In step 104, the administrator may configure the time limits for the particular computer system such as the total time of computer use per day per user and any times that use of the computer system is not permitted, such as during study times or after bedtime. In step 106, the administrator may select either the free service (described in more detail below with reference to FIG. 11) or the subscription service (described in more detail below with reference to FIG. 12) for the particular computer system. In step 108, the administrator may configure the content of the manager tool and select the exams if examinations are enabled in accordance with the invention. In step 110, the manager tool may receive the terminable process information from the server computer web site in accordance with the invention. In step 112, the administrator may select the programs to be limited/terminated when started by the user and performs any remaining configuration of the manager tool in accordance with the invention. In step 114, the configuration is completed and the settings are saved so that the manager tool may be started. In accordance with the invention, the configurations set forth above may be different for each computer system and is customizable. In addition, the manager tool may be configured for one or more different users of the computer system so that, for example, a family home computer system may have a first set of configurations for a 6 year old child of the family and a second set of configurations for a 14 year old child. As another example, a school may configure its manager tool so that there is a different configuration for each grade level user. The set of configurations for each user may be stored in the score store 62 shown in FIG. 3 along with other configuration and user information and data.

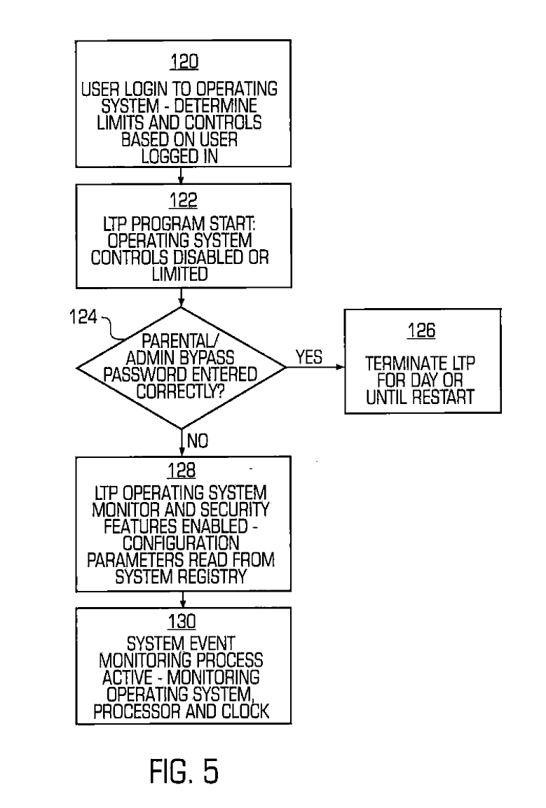

FIG. 5 illustrates the operation of the manager tool in accordance with the invention when the operating system of the computer system is started. In step 120, the user may login into the operating system wherein the configuration for the particular user (determined based on the user login) including the time limits and controls are determined. In step 122, the manager tool is started that disables or limits the operating system controls, such as the task manager, the clock, access to the registry, certain keyboard functions and/or access to administrative tools. In step 124, the manager tool prompts the user for an override password and the user has a predetermined amount of time, such as two minutes, to enter the override password. If the override password is entered correctly, Learn then Play's program termination, shutdown, time limit, learning and exam features are disabled for the day or until restart in step 126. This bypass password allows the authorized administrator to bypass the manager tool functionality and use the computer system. The features can be re-enabled by the parent/administrator by going to a specific re-enable timer located in the Learn then Play program folder (available by navigating to Start, Programs, Learn then Play). When the bypass password is not correctly entered (such as when the user is a child that does not know the password), the manager tool monitors the operating system and enables the security features in step 128 using configuration parameters read from the system registry. Then, in step 130, the manager tool monitors the system events which is described in more detail with reference to FIG. 9 below. The manager tool thus starts several processes on the computer. The processes in accordance with the invention may include:

1. Monitoring of all programs and applications the user starts on the computer;

2. Checking to ensure that Learn then Play is running at all times (unless bypassed by parent/admin);

3. Checking the time to see whether the user has been on the computer for the maximum time specified by parent/admin or is on at an allowed time. If not, Learn then Play issues a command that forces the computer to shutdown; and

4. Checking to see if the system is configured for learning/exams. If it is, Learn then Play checks the time interval for learning and exams and then, based on computer use time or other factors described below, regardless of what type of program is running or what the user is doing, takes over the entire screen, places restrictions on the keyboard to prevent task switching or the starting of any other program, displays learning content and/or exam that is either obtained locally Oust math) or that is retrieved through an Internet connection from Learnthenplay.com. No program in the operating system is suspended by Learn then Play—rather, the person using the computer is given a short notice that the learning/testing will be starting and then Learn then Play overtakes the entire operating system. Learn then Play prevents access to the running programs rather than suspending a particular/specific application or program. Learn then Play is an operating system control mechanism.

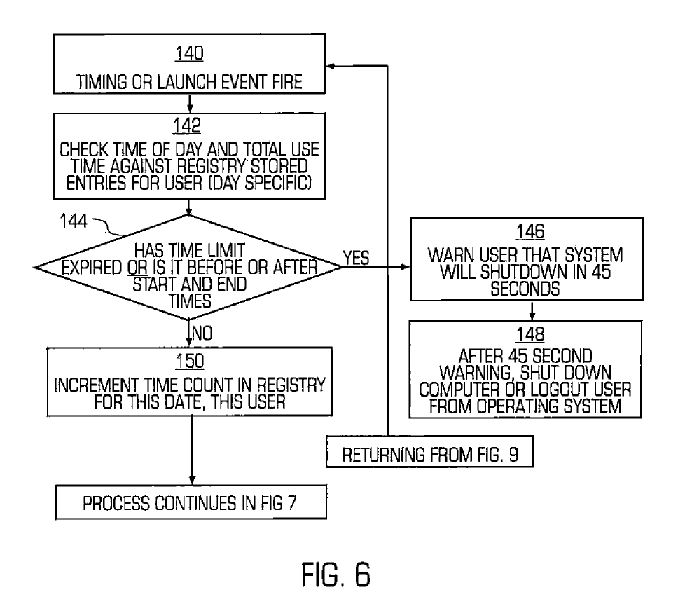

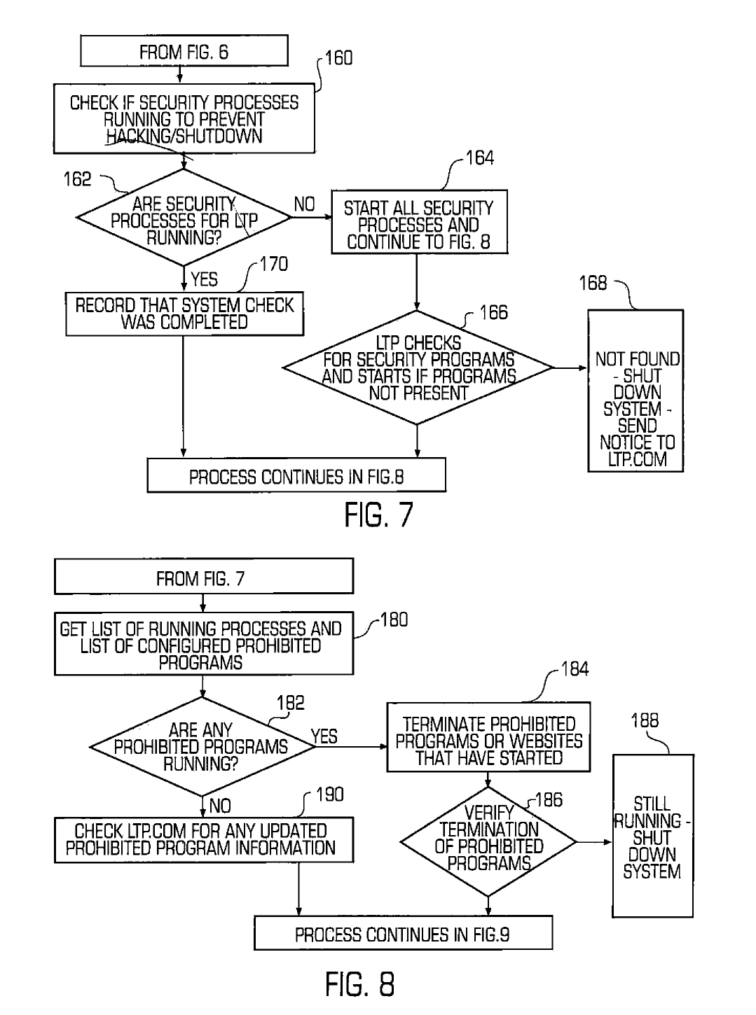

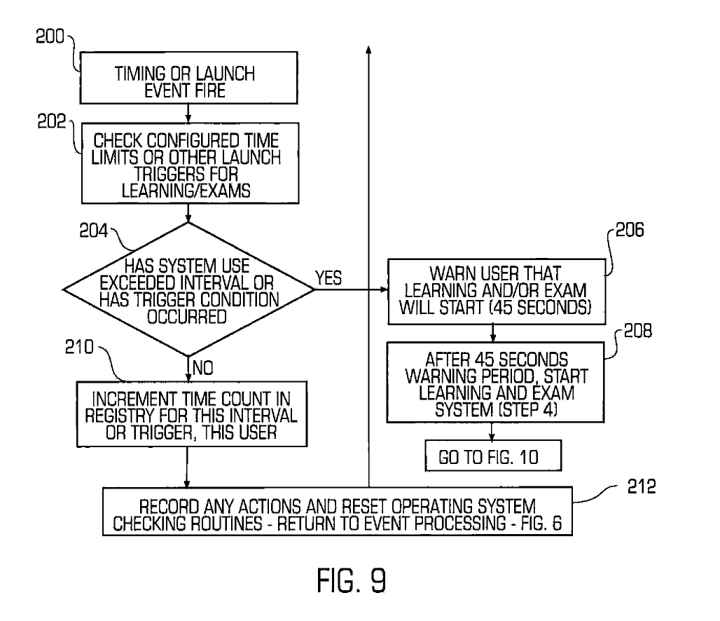

FIG. 6 illustrates an aspect of the operating system monitoring in accordance with the invention during which use times and limits are checked which is one of the processes executed when the manager tool of the present invention is activated on a particular computer system. This process in step 140 starts at the operating system level, within Windows, whenever a timing or launch event occurs. The above process may be implemented in a preferred embodiment in the msLtPsys.exe software file/module that is part of the manager tool. In step 142, the process checks the time of day and total time use for the user against the registry stored entries for the user as well as allowed start time (e.g. 5 a.m.) and end time (e.g. 10 p.m.). The process also checks the system registry to determine the user configured “max time” for this user for the particular date wherein the days of the week can have different times for each user. For instance, a 15-year old user may be allowed 3 hours per day between 9 a.m. and 7 p.m. on school days and 8 hours per day on weekends between 9 a.m. and 11 p.m.

In step 144, the process monitors the operating system conditions and determines if the time limit has expired or if the current time is before the allowed start time or after the allowed end times for the user. If maximum time has been reached for this user, this day or if the user is attempting to logon before he or she is allowed to start using the computer or after the latest time he or she is allowed to use the system, the LtP monitoring program generates a warning to the user in step 146 and shuts down the computer or logs the user off the computer system in step 148. The option to log the user off of the computer system or shut down the computer system is configurable and an appropriate selection may be made for each user.

If the user is below the maximum time allowed and is within allowed operating times, the system will increment the time count the user has been on the system for the day in the system registry for that user and that date in step 150. This value is updated and compared each time the operating system monitoring program check is performed. After checking these items, the process moves on to check the next set of conditions as shown in FIG. 7.

FIG. 7 illustrates another aspect of the operating system monitoring in accordance with the invention during which security program running status is checked. In step 160, the LtP operating system management program checks to see if its security and hack-prevention processes are running. These security processes constantly check to make certain that the Learn then Play software is running in step 162 and, if it is not running, causes it to restart. There are up to 5 different security checking processes that the LtP Operating System Manager starts during operation.

If any of these 5 security programs are not running (which is tested in step 162), the Learn then Play software processes tries to start them in step 164. If the LtP Operating System Manager cannot find the security programs on the system, it assumes the user/child is trying to “hack” or disable the LtP Operating System Manager (step 166) and it causes the computer to shut down after warning the user in step 168. It also notifies the LtP Web server and an e-mail is sent telling the parent about this possible security breach. Returning to step 162, if the security processes are running, then the process records an indication that the check was completed in step 170. After checking these items, the process moves on to check the next set of conditions in the process that is described with more detail with reference to FIG. 8.

FIG. 8 illustrates another aspect of the operating system monitoring in accordance with the invention during which prohibited programs and processes are checked. In this process shown in FIG. 8, the LtP Operating System Manager checks the system registry and reads in parent selected “prohibited programs” and the running processes in step 180. The manager tool allows the parent, from the LtP website, to choose from a list of programs or add programs to their list that the parent does not want the child to be able to run while using the computer. LtP provides a base list that is regularly updated of these programs. LtP also has a rating system where LtP rates programs. Parents can, on the LtP website, have LtP automatically prohibit programs that rate at a particular level (for instance, mature level programs).

When LtP Operating System Manager runs through this process, it checks to see all programs running on the computer and then compares the list of prohibited programs against those running on the system in step 182. If prohibited programs are running, the process terminates the prohibited programs or websites in step 184 and then confirm termination of the prohibited programs in step 186. The prohibited program may start for a number of seconds, but when the process checker runs, the LtP Operating System Manager will terminate those prohibited programs—usually within 120 seconds. If the prohibited programs are not confirmed as being terminated, the computer system is shut down in step 188.

Returning to step 182, if there are not any prohibited program running currently, the process (through the LtP Operating System Manager) will check the LtP Website profile in step 190 for the child using the system to see if the parent has selected any additional prohibited programs/processes. If any new programs/processes are found in the profile stored on the remote LtP Web server, these processes will be added to the list for the particular child/user. After checking these items, the process moves on to check the next set of conditions in the process described in more detail with reference to FIG. 9.

The operating system manager, as set forth above, restricts the content that may be viewed/used by a particular user or any user of the computer system that is executing the operating system manager. The content restriction function may be implemented by monitoring operating system messages as well as incoming/outgoing data from the operating system ports to assess whether the content should be restricted. The content restriction may include either or both information/data content restriction and program or operations restrictions. The information/data restriction may be implemented using an intelligent frame restrictor (IFR) software module that captures and updates itself with key phrases and words wherein the phrases and words are assigned a “level” of “offensiveness” that determines the phrases or words for which a piece of content that contains that word or phrase will be restricted by the operating system manager. The module is 1) fed data as it is received in operating system messages prior to, during or immediately after processing by the core operating system (depending on the type of operating system message); and 2) fed data as it is received by the socket/ports that the module is monitoring during the operation of the operating system monitor. The parent/administrator can select an “offensiveness” level and the module then checks the inbound data and messages as they flow through the operating system. If an operating system message is received that violates/exceeds the selected offensiveness level, the module intercepts the requests by the application being called to display the offensive data (i.e. Internet Explorer, Mozilla Firefox, Netscape, AOL Instant Messenger or an internal program) and prevents the application from opening and/or displaying the offensive content. If the application is already open, the operating system manager and the module either instantly terminates the application or re-routes the application to alternate data before the offensive information/material is shown and/or displayed.

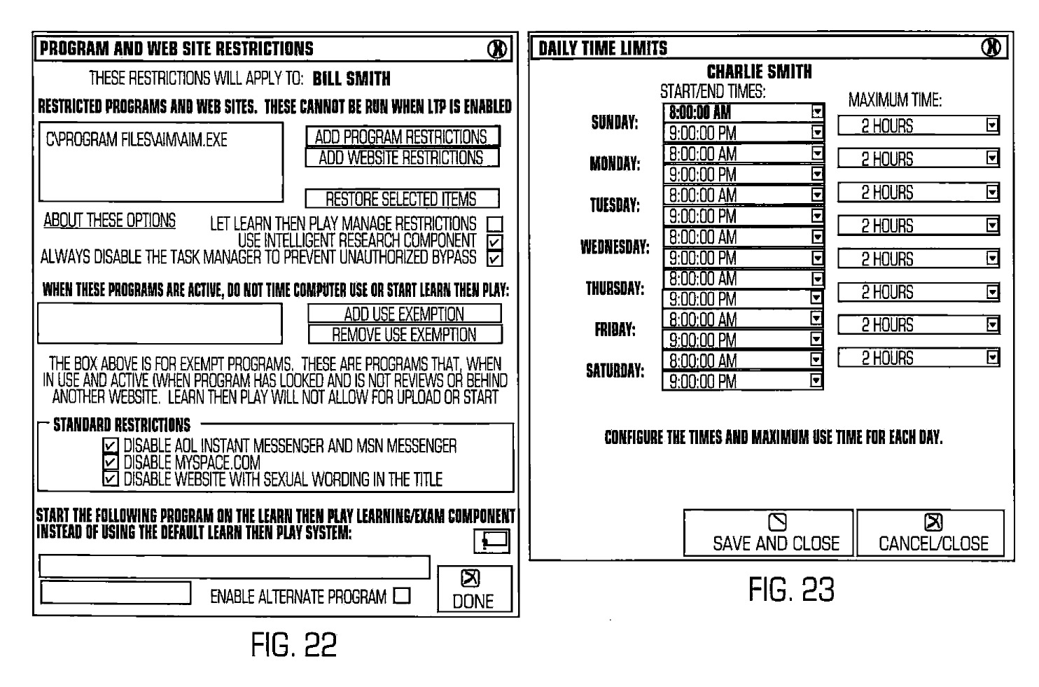

In order to restrict the program/operations, the system server has a user interface that a parent and/or administrator can log into in order to restrict programs or operations wherein information from each client O/S control installation has also been passed to the server. Then, the parent/administrator, on the fly, can choose from a list of restricted programs and operations. For instance, the administrator/parent can login via the website, select a particular child (only children or accounts linked to them) and see a host of information about the site. The system may have at least three distinct pages including a first webpage (described below in more detail with reference to FIG. 22) that provides the parent with a list of restricted websites and programs wherein the parent can choose from specific, identified programs within Learn then Play's regularly updated database or can enter their own information. These programs and/or websites that have been chosen by the parent/administrator become part of the associated child's “restriction” list. The restrictions for a particular program can be set to ALLOW or DENY. When in the DENY mode, the child or adult user managed by the Learn then Play client component will be restricted from ALL websites and/or programs EXCEPT those chosen by the parent administrator. When in ALLOW mode, the child/adult users managed by the LTP client are able to access all websites and/or programs EXCEPT those selected by the parent administrator. The parent can also choose to let Learn then Play manage the restrictions which then causes the Learn then Play system to automatically restrict known programs and websites that are updated regularly based on a child's age, gender and other configurable factors.

The restriction module may also include a webpage (described below in more detail with reference to FIG. 23) that allows the parent/administrator to control login times, learning times and learning control features for the Learn then Play client for a particular child or user. The server component has this information because it is sent to the server each time the client is updated by the parent/administrator whether the configuration change is made via the client interface or the server (web) interface. The parent can then pick the times of use, maximum time per day, bonus for successful learning, subject matter, difficulty as well as a variety of other items. The parent also has a “Shut Down User Now” button. From the Website, if a parent is on travel and receives a call and determines a child's computer use must be changed and that use should be terminated rapidly, the parent can select Shut Down User Now. Within a few minutes, the client will receive this request and shut down the computer. The parent/administrator can provide a message immediately to the child/user of the computer as well wherein the message can be accompanied by a function—such as a task that must be completed (homework, etc.) or individually. The Learn then Play tray manager on the client may notifies a user when a message has been received by a parent/administrator or other user.

The restriction module may also include a webpage (described below in more detail with reference to FIG. 22) that allows the parent to control computer control restrictions. For instance, the parent can turn off the user's ability to get to the task manager or can switch to the Learn then Play learning shell rather than the Windows shell. The parent might want to disable the ability to edit the registry or perform certain computer operations. The parent/administrator can also bypass Learn then Play—so, if a child's time has run out, from the Website, the parent, who might be thousands of miles away, can bypass Learn then Play and allow the child back onto the computer.

Thus, the IFR component, which is running constantly with Learn then Play, takes in the information on the restrictions and controls, and from the server or based on what is stored on the computer for that user, immediately captures requests to applications (either running to about to be launched) through hooks that attempt to go to restricted websites or that contain terms that are deemed to be unacceptable content to the module. So, instead of being “program” specific, the IFR sits within the entire operating system monitoring all programs, web browsers or otherwise, and data coming in as operating system messages or through the sockets/ports. It then shuts down programs and web browsers if the content is one of the restricted sites or programs or if the information/data falls within the definition of improper content.

The IFR also receives any changes made by the parent on the Learn then Play website. So, if a parent is in New York and the child computer is in California, the parent can login to the Website from their location in New York, select the particular child, make the configuration/restriction/control changes described above, and the client receives those changes on the client and updates the client to include the new restrictions, controls, etc. as specified by the parent. The IFR also monitors how long a person is using any program or at any Website and monitors that information based on total time on that program or at that site as well as the total time that the program and/or site was the foreground/active window. So, the IFR captures the total time a program/site was running as well as total time that the program/site was actually the active, in-use application/site. This information is tracked into the LTP databases for reporting back to parents/administrators. The IFR knows the INSTANT a program/site gets focus on the operating system.

FIG. 9 illustrates another aspect of the operating system monitoring in accordance with the invention during which learning/exam trigger conditions are checked. The process is launched after any timing or launch trigger event in step 200. During this process, the operating system monitor checks to see if the configured time limits (for the particular user) or other launch conditions/triggers for learning/exams has been met in step 202. In more detail as shown in step 204, the process determines 1) if the user has been logged onto the operating system, regardless of what programs they are running, for a specified period of time (total computer use per day value divided by configured time interval factor) and then the process determines if it is time for learning or exam based on the configured interval settings/computer usage settings; or 2) the user has launched a particular program/process specified in configuration by parent/administrator a number of times OR has accessed programs “weighted” higher as a factor for triggering startup to determine if it is time for learning and exam process. For instance, the parent configures the system to launch learning/exams when the child/user has started a particular computer program on the system 3 times during that day or specified time span (configurable by parent—5 times in any week, for instance.)

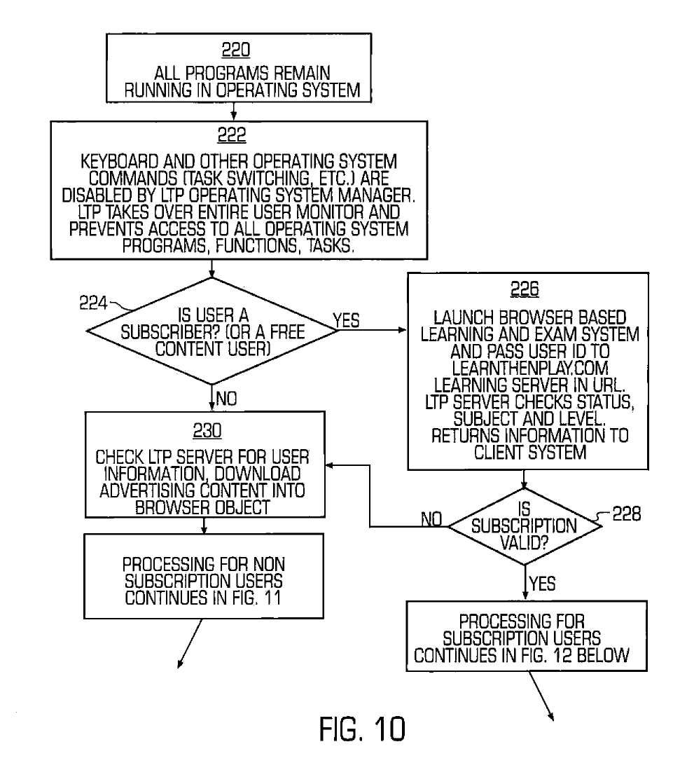

If either of these events is true, the LtP Operating System Monitor program issues a warning to the user in step 206 and then, after a predetermined waiting period, such as 45 seconds in a preferred embodiment) causes the learning and exam process (described in more detail with reference to FIG. 10) to start in step 208. If the events are false and the process trigger was setoff by the launch of a new process and that process matches the name of a configured “triggering” program, the increment of the number of times launched is increased for the configured time span in step 210. If the timer is firing on a per minute basis, the use record is incremented accordingly in the operating system registry. After all steps have processed, if no terminating event is triggered, the system returns to Operating System monitoring mode in step 212 and awaits another event that will check the conditions. This may be process launch on the operating system, clock change, security program notification/call-back or execution.

FIG. 10 illustrates a learning and examination process in accordance with the invention. In the preferred embodiment, the Learning and Exam process is a client-server, browser based software system that has a client portion that generates the user interface (as described below) and receives the user responses and a server portion that controls the operation of the client portion. The client portion further comprises a plurality of lines of computer code executed by the processor of the user computer system to implement the process described below. This process operates based on total computer usage (time per time span (both configurable)) or based on the number of times a particular application is fired or based on performance evaluation formulas on the LtP Web server. Processing is not determined based on timed use of any particular application or application/program type. In step 220, during the learning and examination process, all of the programs remain running in the operating system. In step 222, the LtP operating system manager disables the user's keyboard, task switching capabilities, ability to terminate tasks and takes over the entire monitor. During the disabling of the operating system commands, all programs and processes remain running but are not visible to the user. Next, the system checks in step 224 to see if the user is a subscriber to the Learn then Play content system. If the user is a subscriber, then the system launches the learning and exam process (implemented as a browser based software application with a user interface in a preferred embodiment of the invention) in step 226 and passes the user identifier to the server in a URL so that the server can check the status, subject and level for the particular user and returns information to the client manager tool. In a preferred embodiment, the system checks to determine if the subscription is valid by passing a small encrypted value representing the user's LtP ID number in the HTTP Post sent to the LtP learning (Web) server. In step 228, the manager tool checks to see if the subscription is valid and paid up to date. If the subscription is not valid, the user is returned to “free” (non-pay) functions in step 230. If no connection is present and the LtP system cannot get to its Web server, the system defaults to math only, basic questions. If the subscription is valid, the client passes, in an encrypted HTTP Post to the LtP learning (Web) server any updated configuration values the parent may have set on the client system and subscription learning and exam process continues as shown in more detail in FIG. 12. If the user is a basic user that does not get charged a fee and has downloaded the LtP Operating System Manager for free, the LtP system downloads advertising materials in step 230 that will be displayed during the basic math quiz process. An HTTP Post is sent to the server with the free user's LtP ID #. The server knows the user's age, country, city and level and sends advertising based on these and other demographic factors. The learning and exam process for a non-subscription user is shown in more detail in FIG. 11 which will not be described in more detail.

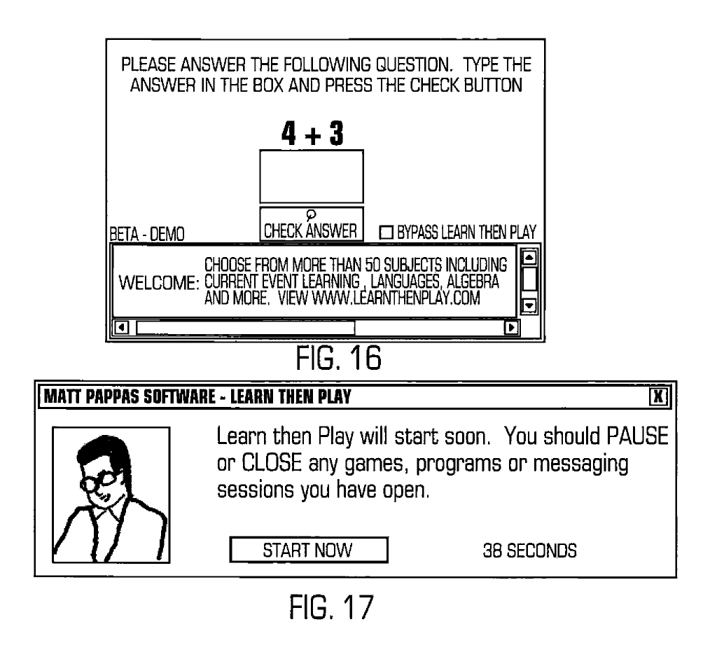

FIG. 11 illustrates the learning and examination process for non-subscription users in accordance with the invention. In a preferred embodiment, the process below is implemented in software having a plurality of lines of computer code executed by the computer system to implement the steps and functions of the process. In step 240, the number of questions and the level of the questions are retrieved from the system registry for the non-subscribed user. The system randomly generates numbers for addition, subtraction and multiplication questions. The difficulty of the question is determined by the child user's age (the child logged in). In step 242, advertising based on various demographics of the user, such as for example the child's age, gender, country, city and level, are downloaded from the server and shown at the bottom of a question screen as shown in FIG. 16. In step 244, a math question (the only type of question presented to the non-subscription user in the preferred embodiment) and the advertising with links are displayed to the user as shown in FIG. 16. In step 245, the operating system monitor program and the learning and exam program determines if the answer to the question is correct or if the user clicked on an advertisement link. If a link is clicked in step 246, the number of questions the child must answer is divided in half and the child is taken momentarily to the advertiser's Web link. In a preferred embodiment, as each question is answered, the advertisements are rotated and changed. In the preferred embodiment, only one advertiser link can be clicked during any quiz session. In the preferred embodiment, the learning and exam process does not use a database for questions since it generates the questions randomly using a random number generator. In step 248, if the user correctly answers the question, the learning and exam process determines if the user has answered the required number of questions. If the user has answered the required number of questions, then the process records the results in the system registry in step 252 and sends the results via an HTTP POST command to the server and then returns control to the LTP operating system manager in step 254 so that the user can return to using the computer since the learning and exam requirements have been met. Returning to step 250, if the user has not answered the required number of questions, then the process loops back to step 244 and another question is presented to the user. Returning to step 245, if the user does not answer the question correctly, the process generates a user interface notifying the user that the answer is wrong and asking the user to try again in step 256. If the user does not complete the exam in the required time period (the preferred default is 45 minutes) in step 258, the LtP system shuts down the computer in step 260 and prevents the child from logging on for the rest of the day (unless a parent bypasses the LtP system when the child logs in by typing in the parental override password).

FIG. 12 illustrates the learning and examination process for subscription users in accordance with the invention. In a preferred embodiment, the process below is implemented in software having a plurality of lines of computer code executed by the computer system to implement the steps and functions of the process. This process is executed when the user enters the learning and exam process and is a subscriber. In a preferred embodiment, the manager tool may include two levels of subscription including an advanced basic level and a premium level. In step 270, the process retrieves a number of questions and levels from the server based on the user identifier passes via HTTP POST to the web server of the server system. The user identifier is used to determine the profile applicable to the user. In particular, a profile for each subscriber child is stored on the Web server. This profile contains a host of information about the child, including demographics, age and location. Learning lessons provided to the child and questions related thereto are generated based on this information. As an example, a child in Florida will, in some cases, receive different lessons and different questions than a child in Spain. Local historical content and other materials are provided based on this information.

As shown in step 272, if the level of subscription is less than premium, then advertisements based on the user profile are presented wherein the advertisements are downloaded from the web site and shown to the user or, if no connection to the server is available, the default or cached ads may be shown to the user. When the user has subscribed to premium content level, no advertising is displayed. In step 274, a lesson is provided to the user wherein the lesson may include one or more of multimedia, text, sound and/or visual aids. Thus, for the subscription user, the user must go through the lesson before the quiz is given in step 276. The quiz is graphical and the content for each question, as well as the content for the lesson, is retrieved from the leamthenplay.com Web server. Questions, lesson and level as well as a host of other items (wrong answers, etc.) are recorded during this process. The process is timed and, if the user finishes quickly with few errors or attempts at questions before achieving a correct answer, the user level is advanced to a higher level based on a series of criteria managed on the learnthenplay.com server.

In step 278, the operating system monitor program and the learning and exam program determines if the answer to the question is correct. In step 280, if the user correctly answers the question, the learning and exam process determines if the user has answered the required number of questions in step 282. If the user has answered the required number of questions, then the process records the results in the system registry in step 284 and sends the results via an HTTP POST command to the server and then returns control to the LTP operating system manager in step 286 so that the user can return to using the computer since the learning and exam requirements have been met. Returning to step 278, if the user has not answered the required number of questions, then the process loops back to step 276 and another question is presented to the user. Returning to step 278, if the user does not answer the question correctly, the process generates a user interface notifying the user that the answer is wrong and asking the user to try again in step 288. If the user does not complete the exam in the required time period (the preferred default is 45 minutes) in step 290, the LtP system shuts down the computer in step 292 and prevents the child from logging on for the rest of the day (unless a parent bypasses the LtP system when the child logs in by typing in the parental override password).

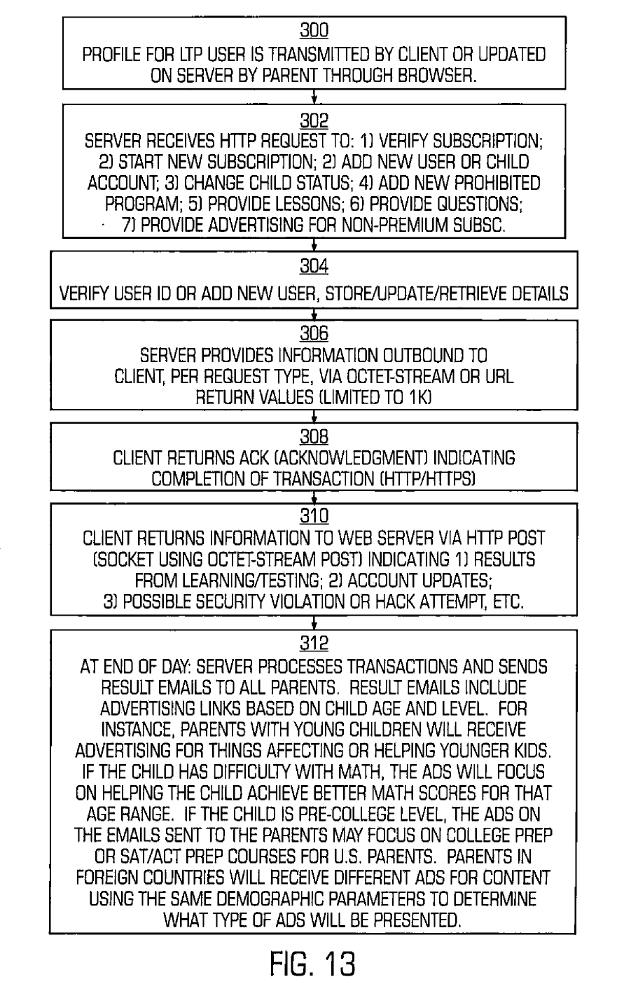

FIG. 13 illustrates server side processing in accordance with the invention. In particular, a unique aspect of the manager tool is the HTTP Web based server side processing engine. The client engine (functions discussed above) provides the client side computer controls and operating system management functions. The server side portion (preferably implemented in software having one or more computer instructions being executed by a processor of the server computer) provides reports to parents, statistics, e-mail, functional algorithms to determine if a child should focus on particular “trouble” subject areas as well as provides the advertising content for non-subscriber users. The client engine functions are available to all users. However, content functions, and some termination control functions, are controlled by the server based system. The server based system is not a traditional LAN server. It is a Web server that receives encrypted information (preferably via SLL/HTTP) via an internet connection or via HTTP POSTs of octet-stream data passed via a socket connection on Port 80 from the client to the server or vice versa. In accordance with the invention, administrators (parents in one example) can also LOGIN to the Learn then Play server, HTTPS secured connection, and view information on their child, including test results, performance statistics, comparative statistical information and other data that is collected regularly as the program runs on the client side computer system. The server side processing functions may include receiving a profile from the client application on the user's computer system or updating the profile through a browser in a process 300. The server may also perform a process 302 of receiving HTTP requests to perform one or more of the following functions: 1) verify the subscription of a user; 2) start a new subscription; 3) change a status of a user, such as a child; 4) add a new prohibited program for a particular user; 5) provide/download lessons to a particular user's client engine; 6) provide questions to a particular user; and 7) provide advertising for a non-premium subscription or a non-subscriber. A process 304 may be performed by the server during which the user identifier (ID) is verified, new user details are stored or existing user details are retrieved or updated. The server may also provide information to a client engine in process 306 or receive an acknowledgment from the client in process 308. The server may also receive information in process 310 from the client engine (preferably via HTTP POST commands) that indicates 1) the results from the learning and testing; 2) account updates; and/or possible security violations for a particular user's computer system. The server may also perform an end of day process 312.

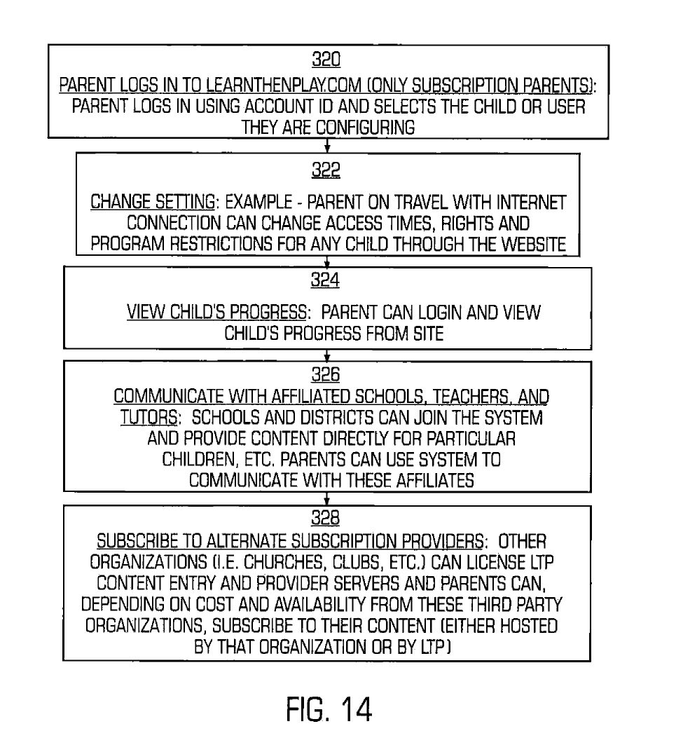

FIG. 14 illustrates an example of the parent functions in accordance with the invention and in particular to the configuration of the learn then play manager tool by the administrator who may be a parent in a preferred embodiment of the invention. In step 320, subscriber parents will have the ability to login to the server (and the website) using the account identifier and select a user to be configured. From the Website, parents can login and change the settings for their child in step 322. For instance, parents go on vacation, receive a report that a child is having trouble in a particular subject area or maybe abusing computer use. From the remote location, by going to the LtP website, the parent can login, choose the particular child, either change content subjects and focus, use time or disable use altogether for a particular child. The website may also permit the parent to view the child progress in step 324. In addition, other organizations can license the LtP server software or host their own content through Learn then Play. An interface is provided by LtP to enter question detail and learning content as well as maintain data on use, membership, etc. A church group or club could use Learn then Play as a tool to control system use as well as provide material out to people that may use common systems or systems from any location (children from home, while at the activity location on shared computers, etc.) in step 326. LtP will also offer affiliation services in step 328 so that school districts can register and use the system to push out content to specific classes, groups, grade levels as well as communicate between the affiliates, parents and other authorized affiliates. Now, examples of the user interface of the manager tool system in accordance with the invention will be described in more detail.

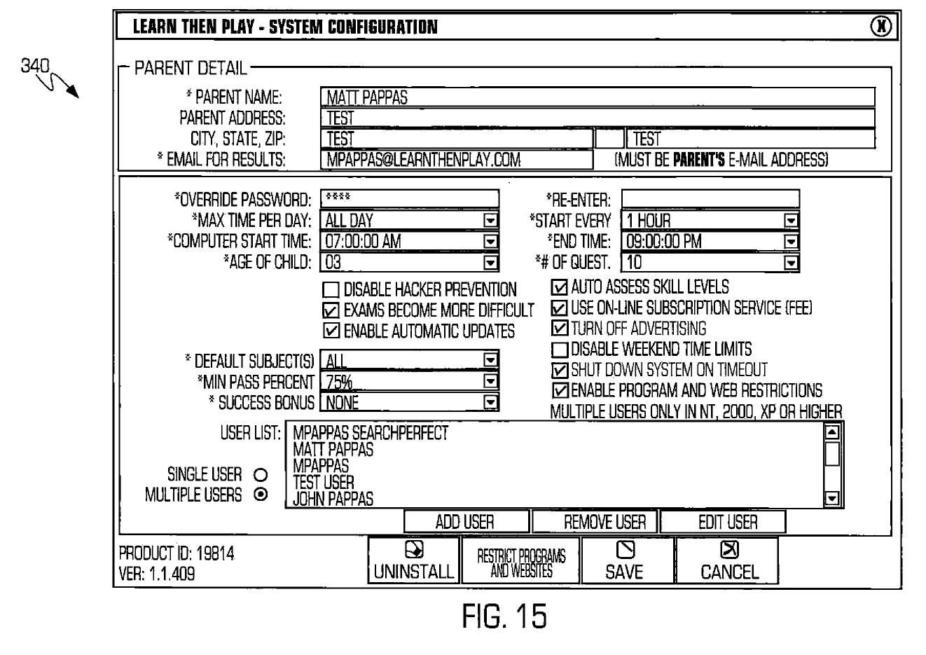

FIG. 15 illustrates an example of the client engine configuration user interface 340 in accordance with the invention. This user interface permits the administrator (a parent in a preferred embodiment of the invention) to configure the client software including at least 1) allowing control of time access for operating system; 2) controlling the time user can access the computer; 3) controlling the time and access ability by user on the computer system; 3) providing exam and learning controls; 4) providing subject controls; 5) providing minimum pass percentage to continue; 6) providing success bonus; and/or 7) providing ability to suspend operation on weekends; and provides additional configuration features.

FIG. 16 illustrates an example of the learning/testing user interface for a non-subscriber in accordance with the invention. The screen takes over the entire operating system screen and will not allow other programs to appear until the process has completed. The advertising appears in the box below the exam question. For the non-subscriber, the exam questions for the basic version are math only and the questions are generated randomly based on the child's age as there is no “database” of questions for this version. By clicking on the ad link, the child can go to a modal Web dialog of the ad for a short time and reduce the total number of questions he/she is required to answer by half. The ad link can be clicked only once per exam. Also, the ad changes with each question presented. No hints are provided to the user for the questions. If the child fails to complete the exam timely with correct answers, the computer is shut down for the day and he or she cannot access the system until the next day or unless the parent enters a special bypass password.

FIG. 17 illustrates an example of a manager tool message in accordance with the invention which is shown to the user if the computer is to be shut down on a time limit or time basis, or if any function is to take place on the system related to the LtP operating system manager program. In a preferred embodiment, this message appears on-top of all other windows. Pressing the Start Now button will bypass the waiting period. Because Learn then Play does not suspend or stop any active program on the computer during operation, this warning is provided to allow the user time to pause any program before the Learn then Play system begins a lesson, quiz, shutdown or other process.

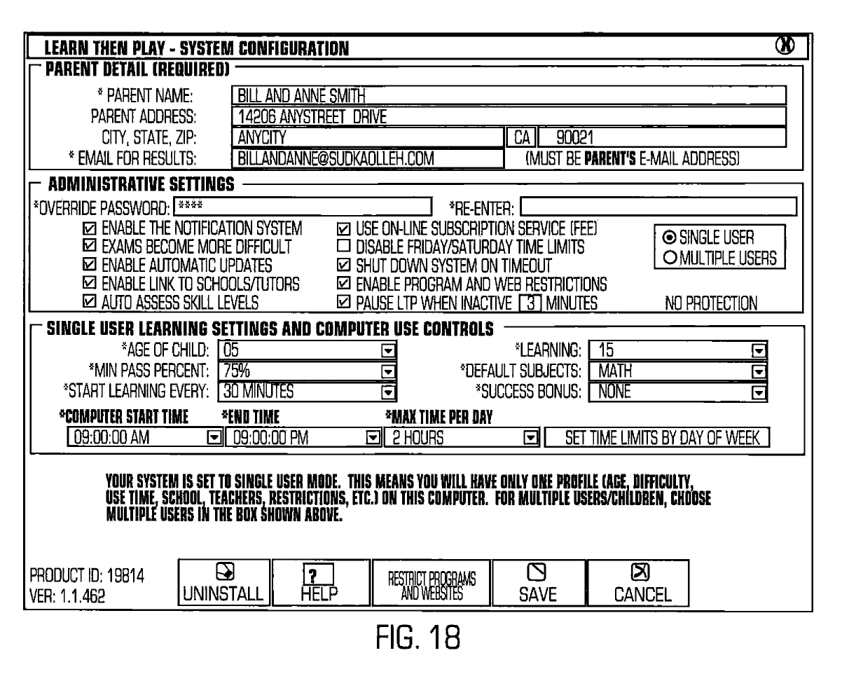

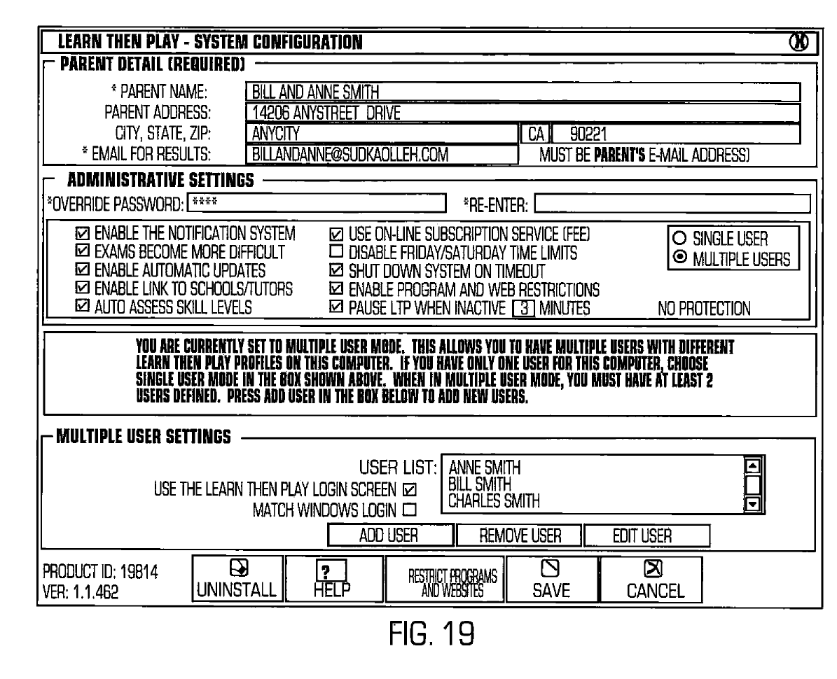

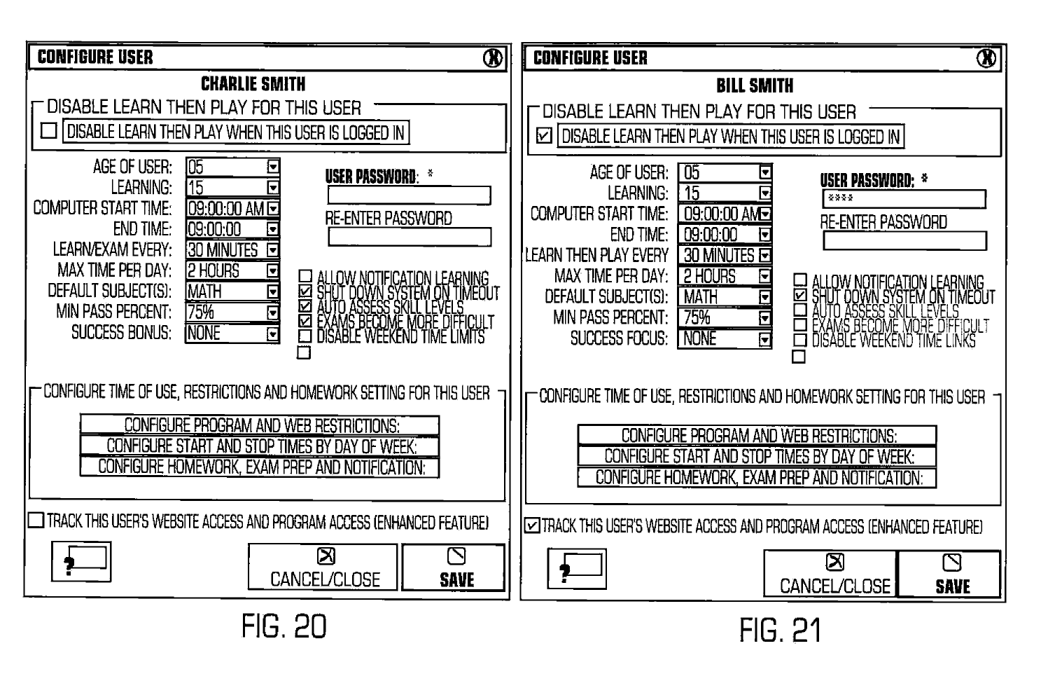

FIG. 18 is an example of a single user configuration user interface of the system. This user interface permits the parent/administrator to set various configuration for a user. The user interface permits the parent/administrator to set the details for the parent/administrator, the override password, the various different functions of the system, and the learning level and computer user control parameters for a particular user. FIG. 19 is an example of a multiple user configuration user interface of the system. In this user interface, the parent/administrator can configure the system for multiple users. FIG. 20 is an example of a user interface for setting configuration settings for a particular user wherein the configuration settings for an individual user may be set and FIG. 21 is an example of a user interface for setting configuration settings for a parent/administrator wherein the checkbox “Disable Learn Then Play when this User is Logged In” is checked so that the various functions of the learn then play system are disabled as long as the proper password is entered into the system.

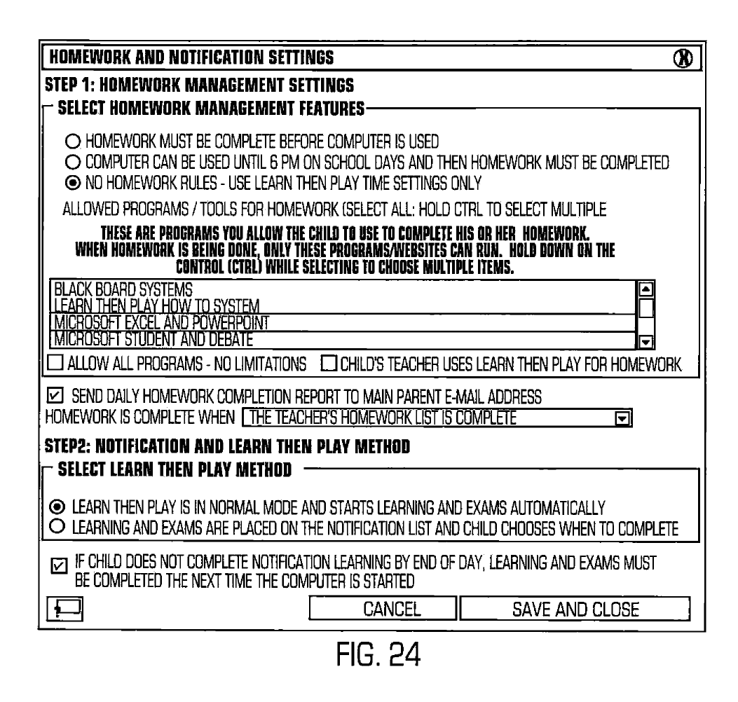

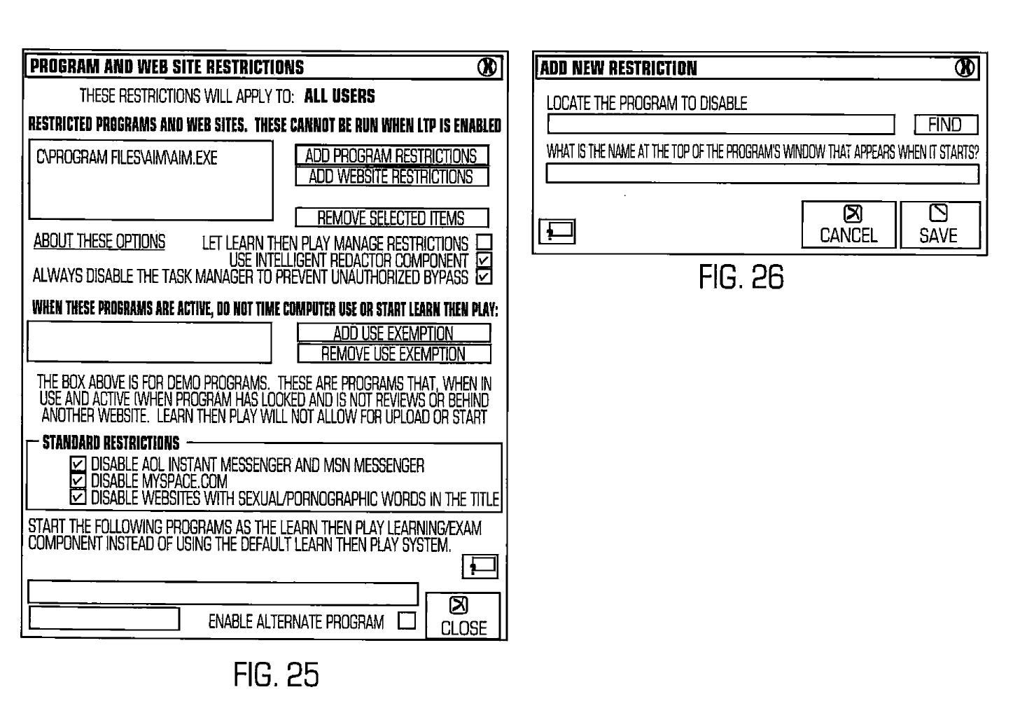

FIG. 22 is an example of a user interface for setting restricted programs or websites for a particular user. The restrictions can also be set for all user as shown in FIG. 25. In FIG. 22, the user interface has a web and program restriction portion, a portion to list programs for which the learn then play learning is not triggered and which does not count against the user's allotted time, a portion for the standard restrictions and a portion in which the parent/administrator can select an alternative learning program. FIG. 23 is an example of a user interface for setting time restrictions for a particular user wherein the times during which the computer may be used each day and total computer use each day is specified for a particular user. FIG. 24 is an example of a user interface for configuring the homework and notification module. The first portion configures how the system treats homework, the second portion lets the administrator/parent specify what programs can be used to complete homework with other programs being excluded, the third portion lets the administrator/parent set how homework is determined to be complete. The preferred embodiment may include six methods (e.g., 30 mins, 1 hour, 2 hours, 3 hours) when the list sent by the teacher/parent and/or tutor is completed or when the parent/administrator/tutor comes to the computer, checks the homework and enters the password to release the system from homework mode. The final portion is for the learn then play method wherein the parent/administrator/tutor can choose the normal “forced” method or the list method that allows the user to pick when to do the homework.

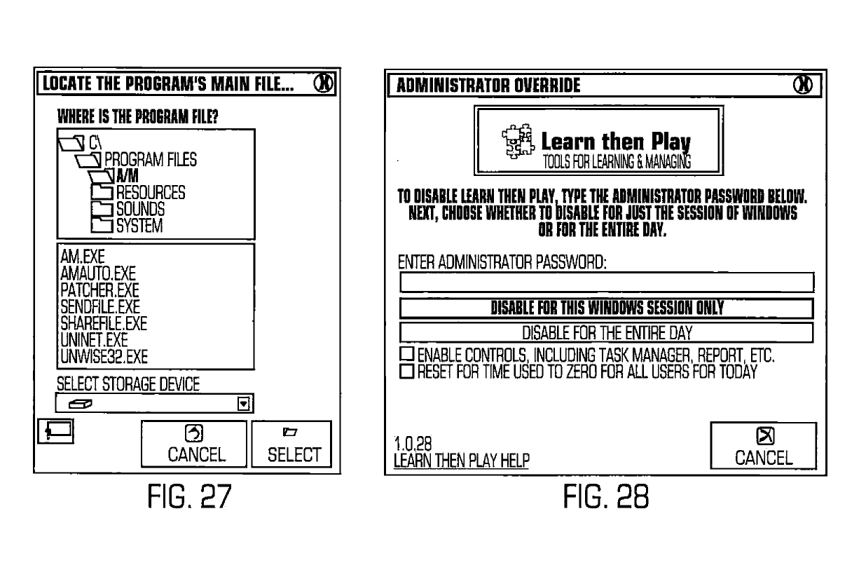

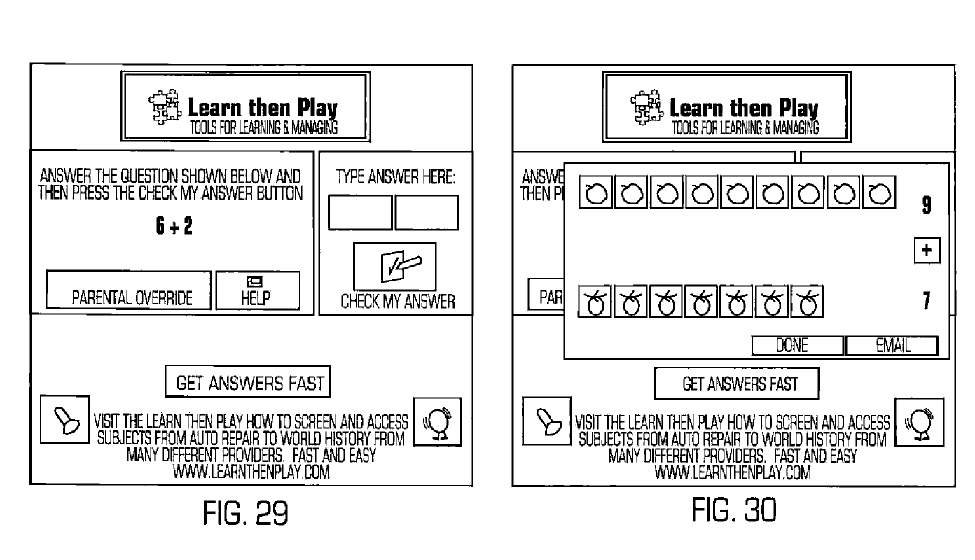

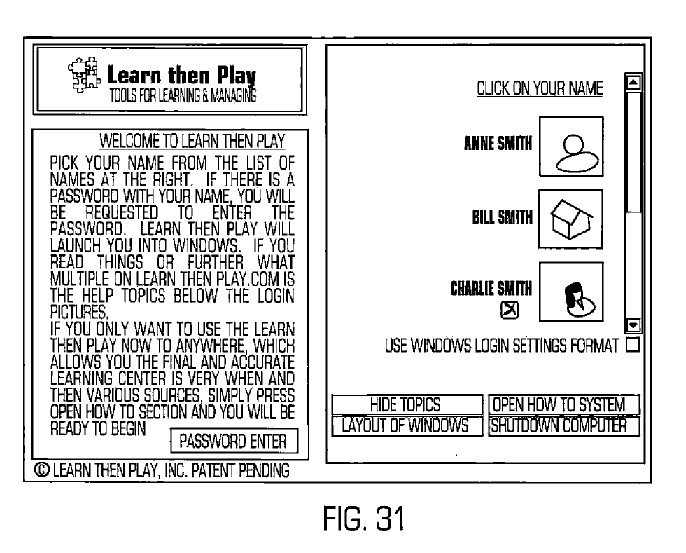

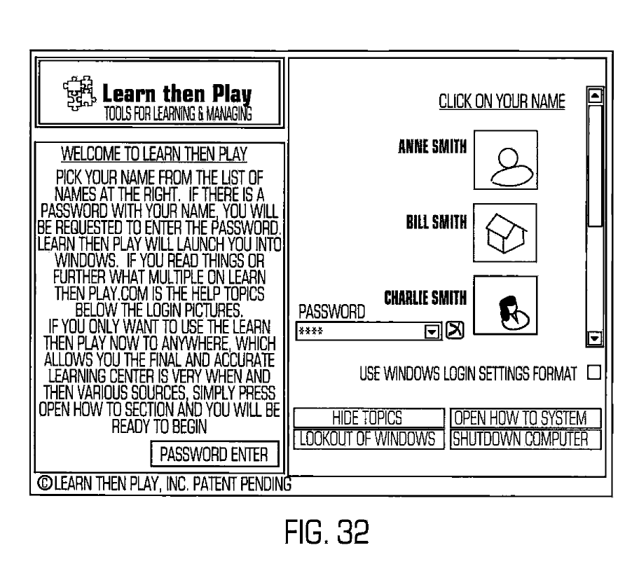

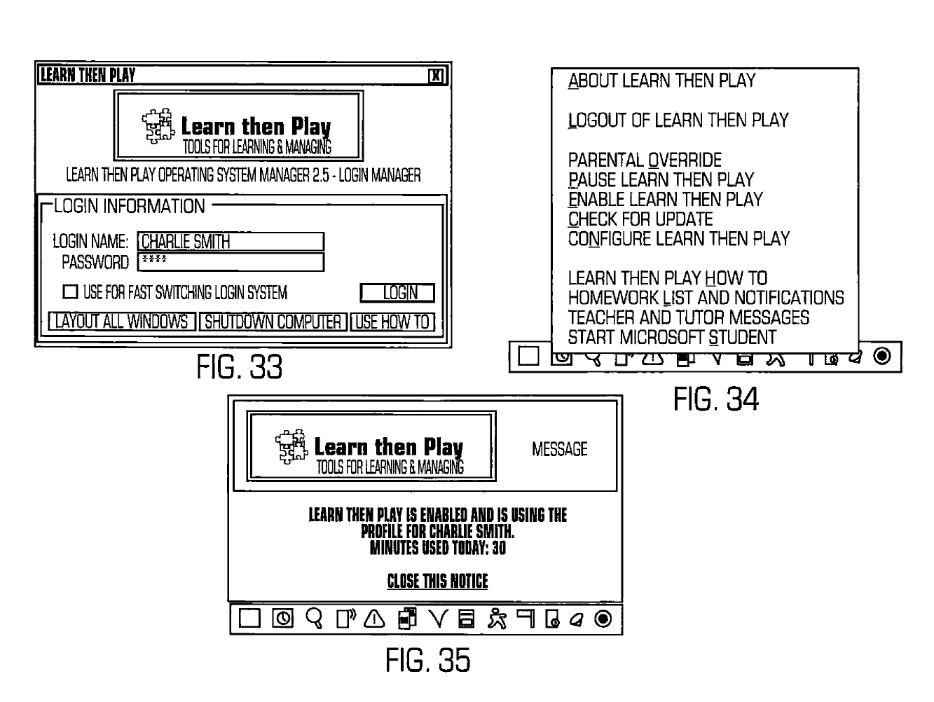

FIG. 26 is an example of a user interface for adding a new program restriction and FIG. 27 is an example of a user interface for selecting a restricted program. FIG. 28 is an example of a user interface for parental/administrator override. Using the override, the parent/administrator can, for a session of windows or the entire day, enable the system resources (task manager, registry editor, etc.) that the system otherwise suppresses and/or reset the time to zero for the day so that a user that has exceeded his maximum time for the day may continue to user the computer. FIG. 29 is an example of a user interface for a math screen for a five year old and FIG. 30 is an example of a user interface for a math screen with hints. FIG. 31 is an example of a user interface for logging into the system and FIG. 32 is another example of a user interface for logging into the system. FIG. 33 is an example of a user interface for secure login to the system. FIG. 34 is an example of a menu that appears for the system. This menu appears when the system tray icon for the learn then play system is clicked. The menu permits the selection of various learn then play features. FIG. 35 is an example of a system message that pops up when the system is enabled and/or disabled or when the parent/administrator is sending a message to the user. The system message may also let a particular user view the homework to be completed.

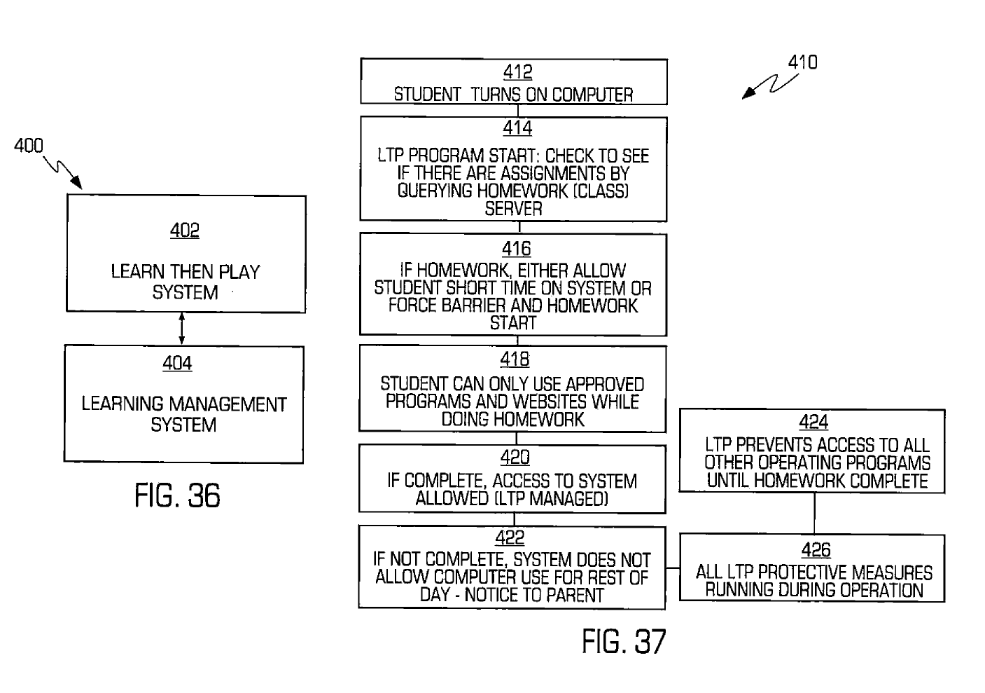

The training system 22 shown in FIG. 1A may be incorporated into a school system 400 as shown in FIG. 36. The training system (shown as a learn then play system 402) may be coupled to and operate in conjunction with a learning management system 404 to provide a school system. The school system forms a learning portal wherein the learn then play system 402 will download the “blacklist” of inappropriate sites and programs for parent/child home computers from the regional school system. Then, when a child comes home from school, the learn then play system will check for homework, either start the child on the homework immediately or after a “free” period of time configured by the parent and then the child must complete the homework using only tools allowed for homework and site access allowed for homework with the system putting its barrier up over the operating system and all other programs, games, sites, etc. Then, once the child has completed the homework, the system releases and allows use of the operating system again and may provide a bonus time period. In a preferred implementation of the school system, the learning management system 404 may be a commercially available Microsoft® Class Server, which is a learning portal.

FIG. 37 is a flowchart illustrating a method 410 for school homework control that can be implemented on the school system shown in FIG. 36. As described above, the learn then play system 402 in FIG. 36 that is described above is an operating system control mechanism and all of the training system elements and methods described above are used for the school system. Thus, when a student comes home from school, the student turns on the computer in step 412. In step 414, the training module is started (the student logs into the learn then play system) and then checks the learning management system used by the school to determine if there are assignments for the student. In step 416, if the student has homework that must be done, the learn then play system 404 permits the student to complete the work or prevent the student from accessing certain programs or sites and forces the student to start the homework. In step 418, the learn then play system permits the student to only use approved programs and websites while completing the homework. In step 420, if the student has completed his/her homework, the learn then play system permits the student to access the other resources of the computer system (while still being managed by the learn then play system.) In step 422, if the student has not completed the homework, the learn then play system does not permit the student to use the computer for the rest of the day and notifies the parent of the student. In step 426, all of the learn then play protective measures (described above) are executed during the continued operation of the system. In step 424, the learn then play system prevents access to all other operating programs until the homework is completed to ensure that the student completes his/her homework. The learn then play system may receive a blacklist of disallowed websites from the school blacklist in cooperation with the school system. In the method, the learn then play system permits the parent to configure a minimum time per day for homework (e.g. 3 hours) or that homework must be submitted. The learn then play system can also check Microsoft Class Server learning portal to see when student presses “submit” and submits homework back to system. Upon completion, the system is released, email sent to parent, etc. Thus, the training system may be used in conjunction with the learning management system to track a student's progress on homework and ensure that the student does not waste time.

The training system 22 may also be implemented and setup as a commercial/business software application (as opposed to the educational version described above.) The commercial application may have the same features as the educational version as well as additional features. As with the educational version, the commercial version controls access to the computer system resources and control access to the content on the computer. The commercial version also permits an employer to track websites accessed, programs run, etc. which also occurs with the education version. The commercial version also has a “network” tool to allow quick and easy review and access of individual employee activities on regular basis. The commercial version allow training (job training, legally mandated training, etc. ) to be pushed out through the system using the system's unique “barrier” requiring that training be completed without access to other programs, etc. The commercial version also permits an employer to toggle a “screen shot” system to take screen shots when and if employee is engaged in activities outside of allowed work function—for instance, if employee visits inappropriate site, system will take a screen shot and record the screen shot. The commercial version permits the employer to specify “free time” periods when restrictions are not effective allowing for personal time on the Internet, etc. The commercial system may also provide an employee with notice when the free periods are in effect and employees may also be granted a 1 hour (period configurable) free period at his/her leisure and can activate the free use period daily using the training system tray manager.

Every embodiment and implementation of the training system (whether the educational version or the commercial version) may include an offensive File Checker and remover module. The module regularly checks file content on the hard drive of user systems and locates offensive content, including offensive video, photo, sound and other offensive files. The offensive files can be locked away from the user/student and then the parent/boss can be notified. This feature runs in the background and periodically checks the hard disk for offensive content in conjunction with the other training system operating system control features. The parents/administrators can configure the level of offensive content to look for as well as specific “offensive” words that will trigger locking away of the file pending review and/or deletion of the file.

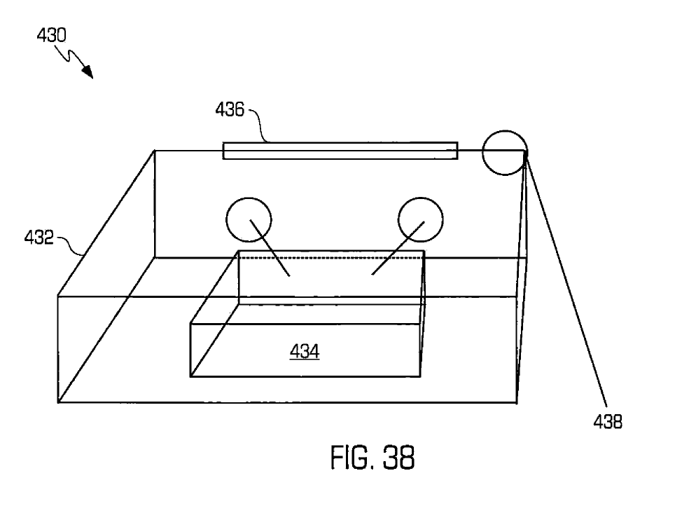

FIG. 38 illustrates an example of a television interface box 430 that incorporates the learn then play system wherein a version of learn then play training system may be integrated into a hardware based processing board. The board or the box 430 then allows the training system to be integrated into a television to control the television content. The control of the television can be accomplished using the hardware 430 shown in FIG. 38 and then using the training system to control a television that is part of the Window Media Centre system. When using Windows Media Centre, the training system can control television access using its software components. For non-Media Centre televisions, the training system controls using the following mechanism or a chip that may be embedded into the TV by television manufacturers. The box 430 can also be integrated into a game console such as Microsoft Xbox, that allows the content of the game console to be controlled.

The illustrative box 430 shown in FIG. 38 may have an interface box 432 that has a processing unit 434 that may execute the training systems software modules as described above and an interface 436 that interface to an incoming signal cable or signal processor and to an outgoing signal line or cable to the television. The box 432 may also have a locking mechanism 438 that prevents the box from being opened without a key and also prevents the incoming and outgoing cables from being disconnected from the box. In operation, the incoming signal passes through the processor that contains an embedded version of the training system software. The training system software can provide one or more of the following function on the box 430 including: a login by username so that the blocking of programs is customized by each user, a parent bypass, timed learning, a maximum time watching the television, television access control, a television watching time start and end time and a way to force homework completion. The processor also includes an outgoing optional connector to the internet or other computer network that permits coordination with computer, television and video game devices for the household.

While the foregoing has been with reference to a particular embodiment of the invention, it will be appreciated by those skilled in the art that changes in this embodiment may be made without departing from the principles and spirit of the invention, the scope of which is defined by the appended claims.

1. A management unit that manages the use of a computing device by a user, the unit comprising:
a processing unit that executes computer instructions;
a memory connected to the processing unit that stores one or more software portions of a client portion wherein each software portion has a plurality of lines of computer code having computer instructions; and
the client portion having an operating system manager portion and a content control portion, the operating system manager portion controls the usage of the computing device by a user by monitoring the operating system of the computing device and the content control portion controlling access to certain programs contained on the computing device and controlling access to certain websites accessible by the computing device.

2. The unit of claim 1, wherein the client portion further comprises a training portion that presents a training opportunity to the user prior to permitting continued use of the computing device.

3. The unit of claim 1 further comprising a computing device that includes the processing unit and the memory.

4. The unit of claim 3, wherein the computing device further comprises one of a personal digital assistant, a wireless email device, a laptop computer, a computer game console, a set-top box and a personal computer.

5. The unit of claim 3 further comprising a main computer coupled to the computing device over a network.

6. The unit of claim 5, wherein the main computer further comprises a server.

7. The unit of claim 5, wherein the network further comprises one of a wireless network, a wired network, a computer network, a communications network and a mobile phone network.

8. The unit of claim 5, wherein the main computer further comprises a learning management server.

9. The unit of claim 8, wherein the learning management server further comprises a Microsoft class server.

10. The unit of claim 6, wherein the server further comprises a training module that communicates a training module to client portion over the network, a configuration module for configuring the time of use of the computing device by each user, and a notification module that notifies a person about the user of the computing device.

11. A method for managing the use of a computing device by a user, the method comprising:
executing a client portion, when the computing device is activated;
controlling, using an operating system manager portion of the client portion, the usage of the computing device by monitoring the operating system executing on the computing device;
controlling, using a content control portion of the client portion, access to certain programs contained on the computing device; and
controlling, using a content control portion of the client portion, access to certain websites accessible by the computing device.

12. The method of claim 11 further comprising presenting, using a training portion of the client portion, a training opportunity to the user prior to permitting continued use of the computing device.
